(19) United States
(12) Patent Application Publication
(10) Pub. No.: US 2011/0070130 A1
(43) Pub. Date: Mar. 24, 2011

(54) In Situ Waste Vegetable Oil Water/Fat/Oil/Particle separator

(76) Inventor: Eric Williamson, North Vancouver (CA)

(21) Appl. No.: 12/878,031

(22) Filed: Sep. 8, 2010

Related U.S. Application Data
(60) Provisional application No. 61/276,043, filed on Sep. 8, 2009.

(51) Int. Cl. B01D 17/025

(52) U.S. Cl. 422/255

(57) ABSTRACT

A device designed to separate fats waters and other contaminants from used vegetable oil.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention pertains to bio diesel production, specifically feedstock for bio diesel production (used cooking oils and other used vegetable/animal oils)

With new standards for bio diesel quality coming into effect, the amounts of fats, waters and other impurities that are included in the bio diesel feedstock (vegetable or animal oils) are becoming increasingly important to control. Production of bio diesel which meets regulatory and/or industry standards is significantly easier with a uniform feedstock. This invention adds uniformity to the feedstock supply by removing water, fats, and other particles from the used vegetable oil.

High quality used cooking oils for bio diesel production have been difficult to segregate from the “yellow grease” supply—“yellow grease” being the homogenized used cooking oil/animal fats product produced “by renderers” this invention solves the problem of segregation and storage by creating a decentralized storage unit.

### BRIEF SUMMARY OF THE INVENTION

“In Situ Waste Vegetable Oil Water/Fat/Oil/Particle separator” Separates the waters fats and other impurities which are mixed into used vegetable oil that is disposed of by restaurants and other users of vegetable oils. It does this without the use of moving parts, using time that is currently not utilized to improve the quality of the oil for bio diesel production. The process is moved forward through the processor by the discharge of the oil by the restaurant.

Traditionally used vegetable oil has been collected by renderers and resold for animal feed, paint, makeup production and other uses. The percentages of fats waters and other particles are not as critical issue for these uses as it is for bio diesel production.

“In Situ Waste Vegetable Oil Water/Fat/Oil/Particle separator” provides a solution to problems encountered in the bio diesel industry. The problems relate specifically to feedstock quality regarding entrained fats, water and other impurities that occur in used vegetable oil that is disposed of by restaurants and/or other users of vegetable oil.

Regulatory requirements for renewable fuels inclusion are coming into force specifying the percentages of bio diesel that should be mixed with diesel. Currently these are very small percentages of inclusion and bio diesel produced from used vegetable oil. As regulatory requirements for renewable fuels percentages increase—the “gel point” of the resultant bio diesel which is produced from used vegetable oil becomes a critical technical issue. To put it into simple terms, fuel filters clog up when there is too much fat mixed in with the bio diesel.

The used vegetable oil feedstock which is produced using this invention has had a large percentage of the entrained fats, water particles removed which makes it to be an excellent bio diesel feedstock.

This results in significant savings for bio diesel producers allowing them to use a higher and higher percentage of used vegetable oils as opposed to new vegetable oils.

To reiterate, this invention provides a decentralized processing and storage system for used vegetable oils which removes the fats waters and other contaminants, providing a high-quality bio diesel feedstock. This invention results in significant savings in storage and processing costs. Additionally due to the dramatically lower cost of used vegetable oils versus new vegetable oils this invention provides a steady source of high-quality bio diesel feedstock at a much lower price.

### IN SITU WASTE VEGETABLE OIL WATER/FAT/OIL/PARTICLE SEPARATOR

Designed such that each “charge” (input of waste vegetable oil) moves the process along simultaneously through multiple processing sections.

Consisting of a series of chambers with “overflows” that are equal to or larger than the volume of the “charge”.

The bottoms of these chambers are designed to help segregate the waters/fats/particles from the used cooking oil, preventing the waters/fats/oils/particles from remixing with the waste vegetable oil. The design of the bottom of these chambers allows the waters/fats/particles to collect in an area underneath the bottoms of the chambers via perforations (small holes) that allow the waters/fats/particles to pass through into a bottom section which can get pumped out regularly.

This design allows the waters/fats/particles to be separated from the waste vegetable oil while allowing the waters/fats/particles to accumulate in the bottom section which is protected from turbulence and disruption and remixing (the particles pass into this section via the perforated bottom of the chambers).

As the waste vegetable oil passes from section to section more and more waters/fats/particles fall out of the waste vegetable oil. This process is moved along by the “charges” (disposal of waste vegetable oil into the unit) and gravity.

As the waste vegetable oil passes through the sections of the processor it continues to drop out entrained waters/fats/particles causing the viscosity of the waste vegetable oil to continually decrease until it is at the end of the processing cycle. When the waste vegetable oil is at the end of the processing cycle it can be conveniently pumped out on a routine basis.

The key features/benefits of this design are:

The vegetable oil is processed at the disposal site—this creates dramatic savings in processing expense.

The fats (which cause increased viscosity and a higher gel point)—are effectively separated by the use of time, time which is not being utilized in the current collection processing systems.—this creates an end product which is an excellent, low viscosity, low gel point, used vegetable oil feedstock for bio diesel production, consistent and easy to work with.

The waters and particles are also separated effectively by the use of time, time which is also not being utilized in the current collection processing systems.—this creates an end product which is a low viscosity, low gel point, used vegetable oil feedstock for bio diesel production. consistent and easy to work with.

After the oil has finished processing—the processor itself acts as a storage unit—this results in significant savings in storage costs

### BRIEF DESCRIPTION OF THE SEVERAL VIEWS OF THE DRAWING

FIG. 1—Drawing depicting In Situ Waste Vegetable Oil Water/Fat/Oil/Particle separator

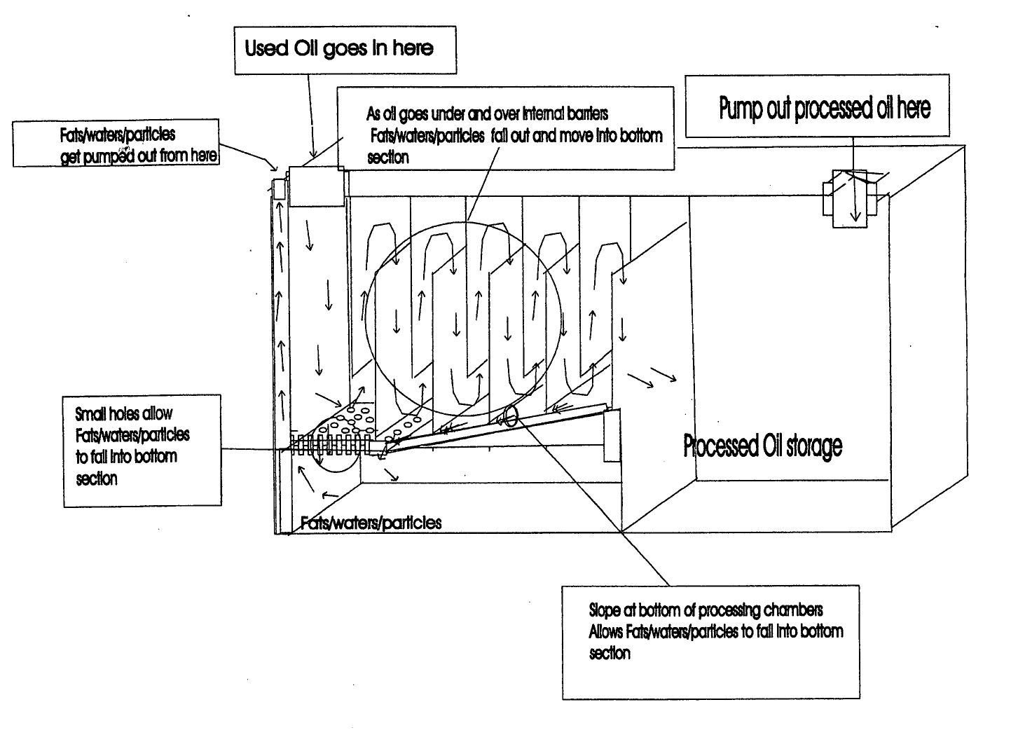

### DETAILED DESCRIPTION OF THE INVENTION

An apparatus for processing vegetable oil, said apparatus comprising a large container composed of

numerous smaller settling chambers designed for separating animal fats, water and other particles from used cooking oil using a gravity, time and the energy associated with the input of disposed oil in the first chamber, the first chamber consists of three areas, the first—an input section for disposal of used vegetable oil, the second, an area where oil which has been primarily settled migrates into prior to overflow in the second chamber, the third, a section of the first chamber which is located below sections 1 and 2 is a bottom section separated by a horizontal bulkhead with perforations which allow water, fats and other contaminations to fall through and to become somewhat protected from subsequent inputs of use vegetable oil, additionally section 3 of chamber one is accessible to pump out the fats, waters, and other contaminations, the second chamber also consists of three areas, the first area of the second chamber consists of an overflow section from chamber one, the second area of the second chamber consists of a section of oil which has been secondarily settled, the third area of the second chamber is common to the third area of the first chamber and is bottom section separated by a horizontal bulkhead with perforations which allow water, fats and other contaminations to fall through and become somewhat protected from subsequent inputs of oil, additionally, section 3 of chamber 2 is accessible to pump out the fats, waters, and other contaminations, the oil is moved forward through the processing chambers one and two until it ultimately overflows into the third chamber which is comprised of two sections, the first section of the third chamber is overflow for chamber number two, the second section of the third chamber is the area of oil which has been processed, the bottom of chamber 3 can be accessed to pump out the cumulative water fats and other contaminants, the size of the chambers is dependent upon the frequency and size of the used vegetable oil disposals as it relates to the time required to separate the fats waters and other contamination each chamber provides an incremental increase in quality and incremental decrease in viscosity, section 3 of chambers number one and two are critically important to not allowing separated fats waters and other particles to become re-entrained in the used vegetable oil, they provide an area above the separated fats and waters and other particles which allow the settled vegetable oil to pass-through into chambers 2, 3, 4, 5 (as many chambers as is necessary) without disturbing and reentering the separated fats waters and other particles

the final chamber act as a storage containor for the final product.

1. An apparatus for processing vegetable oil, said apparatus comprising a large container composed of numerous smaller settling chambers designed for separating animal fats, water and other particles from used cooking oil using a gravity, time and the energy associated with the input of disposed oil in the first chamber, the first chamber consists of three areas, the first—an input section for disposal of used vegetable oil, the second, an area where oil which has been primarily settled migrates into prior to overflow in the second chamber, the third, a section of the first chamber which is located below sections 1 and 2 is a bottom section separated by a horizontal bulkhead with perforations which allow water, fats and other contaminations to fall through and to become somewhat protected from subsequent inputs of use vegetable oil, additionally section 3 of chamber one is accessible to pump out the fats, waters, and other contaminations, the second chamber also consists of three areas, the first area of the second chamber consists of an overflow section from chamber one, the second area of the second chamber consists of a section of oil which has been secondarily settled, the third area of the second chamber is common to the third area of the first chamber and is bottom section separated by a horizontal bulkhead with perforations which allow water, fats and other contaminations to fall through and become somewhat protected from subsequent inputs of oil, additionally, section 3 of chamber 2 is accessible to pump out the fats, waters, and other contaminations, the oil is moved forward through the processing chambers one and two until it ultimately overflows into the third chamber which is comprised of two sections, the first section of the third chamber is overflow for chamber number two, the second section of the third chamber is the area of oil which has been processed, the bottom of chamber 3 can be accessed to pump out the cumulative water fats and other contaminants, the size of the chambers is dependent upon the frequency and size of the used vegetable oil disposals as it relates to the time required to separate the fats waters and other contamination each chamber provides an incremental increase in quality and incremental decrease in viscosity, section 3 of chambers number one and two are critically important to not allowing separated fats waters and other particles to become re-entrained in the used vegetable oil, they provide an area above the separated fats and waters and other particles which allow the settled vegetable oil to pass-through into chambers 2, 3, 4, 5 (as many chambers as is necessary) without disturbing and reentering the separated fats waters and other particles the final chamber act as a storage containor for the final product.

2. An apparatus for processing vegetable oil, said apparatus comprising a large container composed of numerous smaller settling chambers designed for separating animal fats, water and other particles from used cooking oil using a gravity, time and the energy associated with the input of disposed oil in the first chamber, the first chamber consists of three areas, the first—an input section for disposal of used vegetable oil, the second, an area where oil which has been primarily settled migrates into prior to overflow in the second chamber, the third, a section of the first chamber which is located below sections 1 and 2 is a bottom section separated by a horizontal bulkhead with perforations which allow water, fats and other contaminations to fall through and to become somewhat protected from subsequent inputs of use vegetable oil, additionally section 3 of chamber one is accessible to pump out the fats, waters, and other contaminations.

3. An apparatus for processing vegetable oil, said apparatus comprising a large container composed of numerous smaller settling chambers designed for separating animal fats, water and other particles from used cooking oil using a gravity, time and the energy associated with the input of disposed oil in the first chamber, the first chamber consists of three areas, the first—an input section for disposal of used vegetable oil, the second, an area where oil which has been primarily settled migrates into prior to overflow in the second chamber, the third, a section of the first chamber which is located below sections 1 and 2 is a bottom section separated by a horizontal bulkhead with perforations which allow water, fats and other contaminations to fall through and to become somewhat protected from subsequent inputs of use vegetable oil, additionally section 3 of chamber one is accessible to pump out the fats, waters, and other contaminations, the second chamber also consists of three areas, the first area of the second chamber consists of an overflow section from chamber one, the second area of the second chamber consists of a section of oil which has been secondarily settled, the third area of the second chamber is common to the third area of the first chamber and is bottom section separated by a horizontal bulkhead with perforations which allow water, fats and other contaminations to fall through and become somewhat protected from subsequent inputs of oil, additionally, section 3 of chamber 2 is accessible to pump out the fats, waters, and other contaminations.

4. An apparatus for processing vegetable oil, said apparatus comprising a large container composed of numerous smaller settling chambers designed for separating animal fats, water and other particles from used cooking oil using a gravity, time and the energy associated with the input of disposed oil in the first chamber, the first chamber consists of three areas, the first—an input section for disposal of used vegetable oil, the second, an area where oil which has been primarily settled migrates into prior to overflow in the second chamber, the third, a section of the first chamber which is located below sections 1 and 2 is a bottom section separated by a horizontal bulkhead with perforations which allow water, fats and other contaminations to fall through and to become somewhat protected from subsequent inputs of use vegetable oil, additionally section 3 of chamber one is accessible to pump out the fats, waters, and other contaminations, the second chamber also consists of three areas, the first area of the second chamber consists of an overflow section from chamber one, the second area of the second chamber consists of a section of oil which has been secondarily settled, the third area of the second chamber is common to the third area of the first chamber and is bottom section separated by a horizontal bulkhead with perforations which allow water, fats and other contaminations to fall through and become somewhat protected from subsequent inputs of oil, additionally, section 3 of chamber 2 is accessible to pump out the fats, waters, and other contaminations, the oil is moved forward through the processing chambers one and two until it ultimately overflows into the third chamber which is comprised of two sections, the first section of the third chamber is overflow for chamber number two, the second section of the third chamber is the area of oil which has been processed, the bottom of chamber 3 can be accessed to pump out the cumulative water fats and other contaminants.

5. An apparatus for processing vegetable oil, said apparatus comprising a large container composed of numerous smaller settling chambers designed for separating animal fats, water and other particles from used cooking oil the final chamber designed to act as a storage containor for the final product.
